(19) United States
(12) Patent Application Publication
(10) Pub. No.: US 2026/0187598 A1
(43) Pub. Date: Jul. 2, 2026

(54) METHOD AND SYSTEM FOR GENERATING SUBJECT LINES FOR ELECTRONIC MAILS (EMAILS)

(71) Applicant: HCL Technologies Limited, New Delhi (IN)

(72) Inventors: Atul Singh, Bengaluru (IN); Rupesh Prasad, New Delhi (IN); Lokesh B, Villupuram district (IN); Yogesh T, Coimbatore (IN); Vijaylaxmi Ummarji, Vijayapura (IN); Arvind Maurya, Greater Noida (IN)

(21) Appl. No.: 19/095,106

(22) Filed: Mar. 31, 2025

(30) Foreign Application Priority Data
Dec. 31, 2024 (IN) 202411105239

(51) Int. Cl. G06Q 10/107; G06F 16/3332

(52) U.S. Cl. CPC G06Q 10/107; G06F 16/3334

(57) ABSTRACT

Disclosed herein, method and system for generating subject lines for emails. The method may include inputting a subject line generation prompt to an LLM. The subject line generation prompt includes a sample subject line for an email, a target customer segment, and instructions for alternative subject line generation. The method may further include generating a set of alternative subject lines in response to the subject line generation prompt. For each subject line of the set of generated alternative subject lines, the method may further include determining a score corresponding to the subject line, calculating a customer segment weighted IV corresponding to the evaluation parameter, determining a weighted quality score using the calculated customer segment weighted IV and the score for each of a set of evaluation parameters. The method may further include selecting an optimal subject line from the set of alternative subject lines based on the weighted quality score.

### TECHNICAL FIELD

This disclosure generally relates to targeted marketing, and more particularly to method and system for generating subject lines for electronic mails (emails) for selecting an optimal subject line.

### BACKGROUND

A subject line of a marketing electronic mail (email) is a critical element that requires elements of creativity and specificity to draw attention of a target customer. Currently, drafters of the marketing emails use conventional Generative Artificial Intelligence (GenAI)-based solutions for generating email subject lines. However, GenAI-generated subject lines may be naturally unpredictable (i.e., difficult to be logically deduced or reverse engineered). Moreover, the GenAI-based solutions fail to provide proper explanation or justification for the generated subject lines.

Techniques in the present state of art fail to provide a framework for targeted marketing email subject line generation. There is, therefore, a need for a data-driven solution that leverages GenAI models to generate relevant subject lines for marketing emails adapted towards a target audience.

### SUMMARY

In one embodiment, a method for generating subject lines for electronic mails (emails) is disclosed. In one example, the method may include inputting a subject line generation prompt to a Large Language Model (LLM). The subject line generation prompt includes a sample subject line for an email, a target customer segment, and instructions for alternative subject line generation. The method may further include generating, via the LLM, a set of alternative subject lines in response to the subject line generation prompt. For each subject line of the set of generated alternative subject lines, the method may further include determining a score corresponding to the subject line for each of a set of evaluation parameters. For each subject line of the set of generated alternative subject lines, and for each evaluation parameter of the set of evaluation parameters, the method may further include calculating a customer segment weighted information value (IV) corresponding to the evaluation parameter. The customer segment weighted IV may be a weighted average of an IV for each of a set of customer segments and the target customer segment may be one of the set of customer segments. For each subject line of the set of generated alternative subject lines, the method may further include determining a weighted quality score of the subject line using the calculated customer segment weighted IV and the score for each of the set of evaluation parameters. The method may further include selecting an optimal subject line from the set of alternative subject lines based on the weighted quality score.

In another embodiment, a system for generating subject lines for emails is disclosed. In one example, the system may include a processor, and a computer-readable medium communicatively coupled to the processor. The computer-readable medium may store processor-executable instructions, which, on execution, may cause the processor to input a subject line generation prompt to an LLM. The subject line generation prompt includes a sample subject line for an email, a target customer segment, and instructions for alternative subject line generation. The stored processor-executable instructions, on execution, may further cause the processor to generate a set of alternative subject lines in response to the subject line generation prompt. For each subject line of the set of generated alternative subject lines, the processor may determine a score corresponding to the subject line for each of a set of evaluation parameters. For each subject line of the set of generated alternative subject lines, for each evaluation parameter of the set of evaluation parameters, the processor may further calculate a customer segment weighted IV corresponding to the evaluation parameter. The customer segment weighted IV may be a weighted average of an IV for each of a set of customer segments. The target customer segment may be one of the set of customer segments. For each subject line of the set of generated alternative subject lines, the processor may further determine a weighted quality score of the subject line using the calculated customer segment weighted IV and the score for each of the set of evaluation parameters. The stored processor-executable instructions, on execution, may further cause the processor to select an optimal subject line from the set of alternative subject lines based on the weighted quality score.

In yet another embodiment, a non-transitory computer-readable medium storing computer-executable instructions for generating subject lines for emails is disclosed. In one example, the stored instructions, when executed by a processor, may cause the processor to perform operations including inputting a subject line generation prompt to an LLM. The subject line generation prompt includes a sample subject line for an email, a target customer segment, and instructions for alternative subject line generation. The operations may further include generating a set of alternative subject lines in response to the subject line generation prompt. For each subject line of the set of generated alternative subject lines, the operations may further include determining a score corresponding to the subject line for each of a set of evaluation parameters. For each subject line of the set of generated alternative subject lines, for each evaluation parameter of the set of evaluation parameters, the operations may further include calculating a customer segment weighted IV corresponding to the evaluation parameter. The customer segment weighted IV may be a weighted average of an IV for each of a set of customer segments. The target customer segment may be one of the set of customer segments. For each subject line of the set of generated alternative subject lines, the operations may further include determining a weighted quality score of the subject line using the calculated customer segment weighted IV and the score for each of the set of evaluation parameters. The operations may further include selecting an optimal subject line from the set of alternative subject lines based on the weighted quality score.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating subject lines for e-mails, in accordance with some embodiments of the present disclosure.

FIG. 2 is a functional block diagram of various modules within a memory of the computing device configured to generate subject lines for e-mails, in accordance with some embodiments of the present disclosure.

FIG. 3 is a flow diagram of an exemplary method for generating subject lines for emails, in accordance with some embodiments of the present disclosure.

FIG. 4A is a table representing experimental results for IV computation of readability parameter based on an exemplary dataset, in accordance with an embodiment of the present disclosure.

FIGS. 4B and 4C are tables representing experimental results for IV computations of readability parameter for individual customer segments based on the exemplary dataset, in accordance with an embodiment of the present disclosure.

FIGS. 5A-5E illustrate exemplary graphical representations of a comparison between a raw Generative Pre-trained Transformer (GPT-4) model and a Direct Preference Optimization (DPO) fine-tuned model, in accordance with an embodiment of the present disclosure.

FIG. 6 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

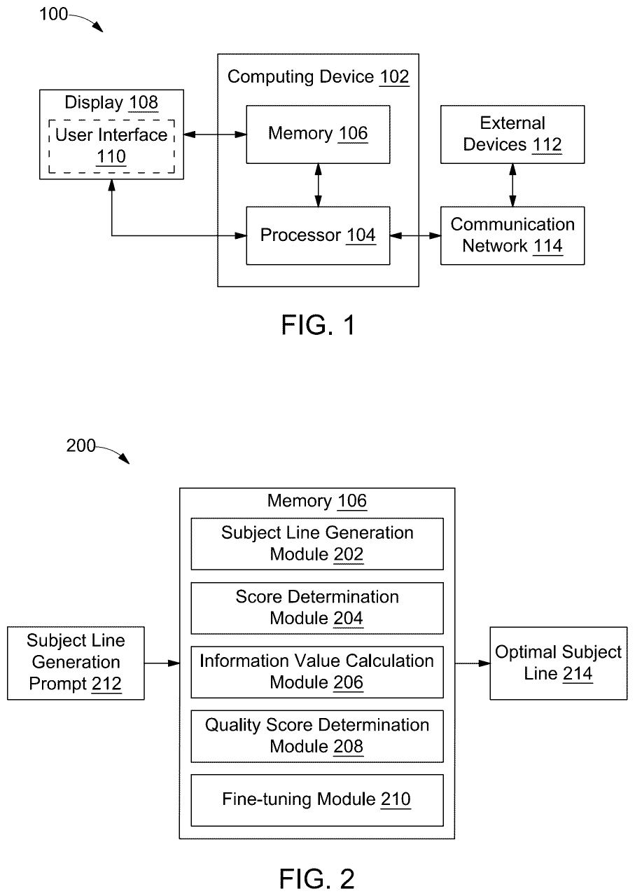

Referring now to FIG. 1, an exemplary system 100 for generating subject lines for emails is illustrated, in accordance with some embodiments of the present disclosure. The system 100 may include a computing device 102 (for example, server, desktop, laptop, notebook, netbook, tablet, smartphone, mobile phone, or any other computing device), in accordance with some embodiments of the present disclosure. The computing device 102 may generate optimally selected subject lines for emails based on a weighted quality score calculated for each subject line.

As will be described in greater detail in conjunction with FIGS. 2-6, the computing device 102 may input a subject line generation prompt to an LLM. The subject line generation prompt may include a sample subject line for an email, a target customer segment, and instructions for alternative subject line generation. The computing device 102 may further generate the set of alternative subject lines in response to the subject line generation prompt. For each subject line of the set of generated alternative subject lines, the computing device 102 may determine a score corresponding to the subject line for each of a set of evaluation parameters. For each subject line of the set of generated alternative subject lines, and for each evaluation parameter of the set of evaluation parameters, the computing device 102 may further calculate a customer segment weighted information value (IV) corresponding to the evaluation parameter. The customer segment weighted IV may be a weighted average of an IV for each of a set of customer segments. The target customer segment may be one of the set of customer segments. For each subject line of the set of generated alternative subject lines, the computing device 102 may further determine a weighted quality score using the calculated customer segment weighted IV and the score for the each of the set of evaluation parameters. The computing device 102 may further select an optimal subject line from the set of alternative subject lines based on the weighted quality score.

In some embodiments, the computing device 102 may include one or more processors 104 and a memory 106. Further, the memory 106 may store instructions that, when executed by the one or more processors 104, cause the one or more processors 104 to generate subject lines for emails, in accordance with aspects of the present disclosure. The memory 106 may also store various data (for example, a sample subject line for an email, a subject line generation prompt, a target customer segment, instructions for alternative subject line generation, a set of alternative subject lines, a set of evaluation parameters, a customer segment weighted information value (IV), and the like) that may be captured, processed, and/or required by the system 100.

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram 200 of various modules within a memory 106 of the computing device 102 configured to generate subject lines for emails is illustrated, in accordance with some embodiments of the present disclosure. The memory 106 may include a subject line generation module 202, a score determination module 204, an IV calculation module 206, a quality score determination module 208 and a fine-tuning module 210.

The subject line generation module 202 may receive a subject line generation prompt 212 from a user through a Graphical User Interface (GUI). The subject line generation prompt 212 may include a sample subject line for an email, a target customer segment, and instructions for alternative subject line generation. The user may be any individual that is drafting an email. In an exemplary scenario, the user may be a marketing professional drafting a marketing email (for example, a promotional email, a newsletter email, a sales email, or the like). The user may or may not be associated with an enterprise.

In an embodiment, the user may provide the sample subject line and the target customer segment through the GUI. In such an embodiment, the GUI may include text boxes for these user inputs. Additionally or alternatively, the GUI may include a set of predefined templates from which the user may select the sample subject line and/or the target customer segment. Further, in such embodiments, the subject line generation module 202 may create the subject line generation prompt 212 based on the user inputs received from the GUI.

The target customer segment may be determined by the user or any other individual (or team of individuals) of the enterprise. In an embodiment, the target customer segment may be determined based on identification of a target demographic division, such as age group, gender, income level, geographic region, customer type (for example, new customer or returning customer), and the like. In another embodiment, the target customer segment may be determined based on identification of a target behavioral segment. Behavioral segments may be defined based on previous interactions, such as response rates (for example frequent responders or occasional responders).

The instructions provide clarity and context to the LLM for alternative subject line generation. Further, the subject line generation module 202 may input a subject line generation prompt 212 to the LLM. The subject line generation module 202 may then generate, via the LLM, a set of alternative subject lines in response to the subject line generation prompt 212. In other words, the LLM may craft ‘n’ number of tailored and engaging email subject lines for targeted customer segments (where ‘n’ is user-defined in the instructions of the subject line generation prompt 212). This approach underscores the efficacy of AI-driven text generation in optimizing marketing content personalization and enhancing audience engagement.

By way of an example, an exemplary subject line generation prompt 212 is described below.

‘You are a creative writer. Can you please write 10 variations of the given email subject line for a marketing email targeting a given customer segment? subject line: “{subject line}”, customer segment: {customer segment}’

The set of generated alternative subject lines may lack explainability or justification. In other words, the LLM-generated set of alternative subject lines may be perceived as random or irrelevant by the user. Therefore, the computing device 102 may perform further processing on the set of alternative subject lines to add an explanation metric corresponding to each of the set of alternative subject lines. The subject line generation module 202 may send the set of alternative subject lines to the score determination module 208. Additionally, the subject line generation module 202 may send the sample subject line and the set of alternative subject lines to the fine-tuning module 210.

Further, for each subject line of the set of generated alternative subject lines, the score determination module 208 may determine a score corresponding to the subject line for each of a set of evaluation parameters. By way of an example, the set of evaluation parameters may include, but may not be limited to, a readability parameter, an action word parameter, a power word parameter, a polarity parameter, a subjectivity parameter, a spam parameter, and the like.

The readability parameter is a composite metric that may evaluate an ease of comprehension of a given text. The readability score integrates a Flesch Reading Ease with a normalized Flesch-Kincaid Grade Level and a Gunning Fog Index, providing a comprehensive assessment of text readability. Range of Flesch Reading Ease is from 0 to 100, range of Flesch-Kincaid Grade is from 0 to 20, and range of Gunning Fog is from 0 to 20. The readability parameter offers a balanced assessment, considering both comprehension ease and educational level required for understanding.

The action word parameter (or verb score) measures the presence and impact of action words (or verbs) in a sentence. The action word parameter may be calculated based on the number of verbs present in a given text. For example, the action word parameter may be 100 when 2 or more verbs are detected in the text, 50 when 1 verb is detected in the text, and 0 when no verbs are detected in the text.

The power word parameter of a given text aims to identify and assess the impact of positive words (or power words) in the text. The power word parameter utilizes a positive opinion lexicon to identify impactful words and scores based on the density of the power words. For example, the power word parameter may be 100 if 2 or more power words are detected in the text, 50 if 1 power word is detected in the text, and 0 if no power words are detected in the text.

The polarity parameter of a given text measures sentiment on a scale from negative to positive (e.g., −1 to +1), aiding in understanding the measured sentiment. In other words, the polarity parameter discerns the emotional tone of the text, aiding in understanding the conveyed sentiment. The polarity parameter may be determined using a supervised machine learning model from a Natural Language Processing (NLP) library (e.g., TextBlob library). In an embodiment, the polarity score (originally on a scale of −1 to +1), may be adjusted on a scale of 0 to 100, where the polarity score of 0 indicates an entirely negative sentiment, 50 indicates a neutral sentiment, and 100 indicates a completely positive sentiment.

The subjectivity parameter evaluates the subjective or objective nature of a given text. In other words, the subjectivity parameter distinguishes between personal opinions and factual information in the text, aiding in content understanding. The subjectivity parameter may be determined based on a supervised machine learning algorithm from an NLP library (e.g., TextBlob library). In an embodiment, the subjectivity score of 0 may indicate a completely objective text and the subjectivity parameter of 1 may indicate a completely subjective text.

Spam detection utilizes predictive machine learning to identify and classify a subject line to be triggered potentially as spam by spam detectors. Trained on an open-source dataset of categorized email subjects, the machine learning model learns patterns associated with spam. The spam parameter of a given text offers a quantifiable measure (percentage) indicating a probability of a sentence being non-spam. In an embodiment, the probability may be multiplied by 100 to get the spam parameter on a scale of 100.

It should be noted that the score determination module 204 may normalize the score for each of the set of evaluation parameters to a scale of 0 to 100, where a higher score is a favorable indication for the text (i.e., subject line). Further, the score determination module 204 may send the score for each of the set of evaluation parameters to the quality score determination module 208.

Further, for each evaluation parameter of the set of evaluation parameters, the IV calculation module 206 may calculate a customer segment weighted IV corresponding to the evaluation parameter. The customer segment weighted IV may be a weighted average of an IV for each of a set of customer segments and may determine the customer response for the email. The target customer segment may be one of the set of customer segments.

As will be appreciated, IV is a statistical tool that measures the predictive power of an independent variable. The IV indicates the ability of the independent variable to distinguish between different outcomes (i.e., dependent variables) based on the information gain provided by that independent variable. In the present disclosure, the IV corresponds to a statistical technique that correlates the set of evaluation parameters (independent variables) with customer response (dependent variables) to determine the relative significance and contribution of each evaluation parameter. The dependent variable used to calculate the IV is the customer response, which is denoted as a binary outcome (i.e., 1 for a positive response and 0 for no response from customer).

To calculate the IV, historical email data may be retrieved. The historical email data may include data corresponding to each of a plurality of historical emails. This data may include a customer response (i.e., responder or non-responder) for each historical email. In an embodiment, the customer response may be recorded in form of binary values, for example a responder may correspond to 1 and a non-responder may correspond to 0. Thus, a number of responders (or a percentage of responders) and a number of non-responders (or a percentage of non-responders) may be obtained from the historical email data. The historical email data may also include scores of the set of evaluation parameters for each historical email.

For conventional IV calculation of an evaluation parameter, a set of continuous bins (i.e., ranges or intervals) may be created for the historical scores of the evaluation parameter. By way of an example, the set of bins may be created based on criteria such as deciles, quartiles, business logic, and the like. Further, the historical data may be divided into appropriate bins. In other words, the number of responders and the number of non-responders in the historical email data may be separately counted for each of the set of bins. For example, if, for a historical email, the score of an evaluation parameter is 25 and the customer response corresponds to a responder, then the number of responders in an appropriate bin for the score (e.g., 21-40) may be increased by 1.

Further, a Weight of Evidence (WoE) may be calculated for each bin through equation (1).

$$W O E = log ( \frac{Percentage of Responders in Bin}{Percentage of Non - Responders in Bin} ) \qquad ( 1 )$$

After calculating WoE, the conventional IV may be calculated for the evaluation parameter using the equation (2).

$$IV = {\sum }_{1}^{n} ( Percentage of Responders - Percentage of Non Responders ) \times WOE \qquad ( 2 )$$

Where n corresponds to a number of bins in the set of bins.

As will be appreciated, for the enterprise or the user, there may be a set of customer segments, each predefined with a unique set of characteristics. In an embodiment, the set of customer segments may be created based on demographic groups (such as age groups, gender, income levels, geographic regions, customer types (e.g., new vs. returning), or the like). In another embodiment, the set of customer segments may be created based on behavioral segments. The behavioral segments may be defined based on previous customer interactions (extracted from the historical email data), such as response rates (for example, frequent responders or occasional responders). The user may require the email subject line to be customized according to the targeted customer segment. Hence, the conventional IV may fail to consider unique nature and behavior of each customer segment.

Thus, the IV calculation module 206 computes the customer segment weighted IV for each evaluation parameter from the set of evaluation parameters. To calculate the customer segment weighted IV, the IV calculation module 206 may obtain the set of customer segments and customer response data associated with each of the set of customer segments, from the historical email data. Further, the IV calculation module 206 may calculate the IV of the evaluation parameter for each of the set of customer segments separately, based on the number of responders and the number of non-responders, using the equation (2). The number of responders and the number of non-responders are obtained from the customer response data in the historical email data.

Additionally, the IV calculation module 206 may assign a weight to each of the set of customer segments based on predefined criteria. The predefined criteria may be based on a number of observations in each customer segment (more populous customer segments may be assigned higher weight). Alternatively, the predefined criteria may be based on strategic importance or user requirements (certain customer segments may be strategically more important and hence, may be assigned a higher weight).

Further, based on the IV of each of the customer segments and the corresponding weight assigned to each of the customer segments, the IV calculation module 206 may calculate a weighted average of the IV for each of the set of customer segments using the assigned weight to obtain the customer segment weighted IV corresponding to the evaluation parameter. The IV of each customer segment may be multiplied by the assigned weight of the customer segment. The product of multiplication of all the customer segments may then be summed to obtain the customer segment weighted IV. By way of an example, the IV calculation module 206 may calculate the customer segment weighted IV (IV_{pw}) for an evaluation parameter ‘p’ across ‘n’ customer segments, using equation (3).

$${IV}_{pw} = {w}_{1} \cdot {IV}_{p 1} + {w}_{2} \cdot {IV}_{p 2} + ⋯ + {w}_{n} \cdot {IV}_{pn} \qquad ( 3 )$$

Where w₁, w₂, . . . , wₙ are weights assigned to the respective n customer segments, and IVₚ₁, IVₚ₂, . . . , IVₚₙ are IVs calculated for the respective n customer segments.

In one example, the customer segment weighted IV for a readability score for a high income customer segment and a low income customer segment may be computed using equation (4).

$${IV}_{readability , weighted} = {w}_{l o w} \cdot {IV}_{readability , low} + {w}_{h i g h} \cdot {IV}_{readability , high} \qquad ( 4 )$$

where w_{low} is a weight assigned to the low income customer segment,
w_{high} is a weight assigned to the high income customer segment,
IV_{readability, low} is an IV calculated for the readability score within the low-income customer segment using the equation (2),
IV_{readability, high} is an IV calculated for the readability score within the high-income customer segment using the equation (2).

It should be noted that behavior (or response) of a customer segment may change with time for an evaluation parameter. So, the IV calculation module 206 may iteratively calculate the customer segment weighted IV at predefined time intervals. Further, the IV calculation module 206 may adjust the customer segment weighted IV of an evaluation parameter based on a time decay. In other words, for each evaluation parameter of the set of evaluation parameters, the IV calculation module 206 may modify a current customer segment weighted IV (i.e., the customer segment weighted IV at current time interval) of the evaluation parameter based on a decay factor and a previous customer segment weighted IV of the evaluation parameter. The decay factor may be indicative of an impact of the previous customer segment weighted IV on the current customer segment weighted IV. The previous customer segment weighted IV may be the customer segment weighted IV of the evaluation parameter calculated at a previous time interval. The modified current customer segment weighted IV (IV_{modified}) for an evaluation parameter may be computed using equation (5).

$${IV}_{modified} = α ⋆ {IV}_{current} + ( 1 - α ) ⋆ {IV}_{previous} \qquad ( 5 )$$

Where IV_{current} is a current customer segment weighted IV,
IVₚᵣₑᵥᵢₒᵤₛ is a previous customer segment weighted IV, and
α is a decay factor.

Thus, the decay factor (a) is inversely correlated to the impact of previous information (or previous customer segment weighted IV). A higher a value reduces the impact of previous information, giving more weight to the current IV (IV_{current}), indicating a quicker responsiveness to recent trends. Conversely, a lower a value increases the influence of the previous IV (IVₚᵣₑᵥᵢₒᵤₛ), reflecting a slower rate of change in customer behavior. Further, the IV calculation module 206 may send the customer segment weighted IV of each of the set of evaluation parameters to the quality score determination module 208.

For each of the set of evaluation parameters, the quality score determination module 212 may receive the score from the score determination module 204 and the customer segment weighted IV from the IV calculation module 206. Further, the quality score determination module 212 may determine a weighted quality score of the subject line using the calculated customer segment weighted IV and the score for each of the set of evaluation parameters. The customer segment weighted IV of an evaluation parameter may be used as a weight for that evaluation parameter to calculate the weighted quality score for a subject line. By way of an example, the quality score determination module 212 may determine the weighted quality score QSₐ for a subject line ‘a’ using equation (6).

$$Q {S}_{a} = {IV}_{w , r} \cdot {s}_{r} + {IV}_{w , aw} \cdot {s}_{aw} + {IV}_{w , pw} \cdot {s}_{pw} + {IV}_{w , p} \cdot {s}_{p} + {IV}_{w , sub} \cdot {s}_{sub} + {IV}_{w , spam} \cdot {s}_{spam} \qquad ( 6 )$$

where, IV_{w,r}, IV_{w,aw}, IV_{w,pw}, IV_{w,p}, IV_{w,sub}, and IV_{w,spam} are customer segment weighted IVs for readability parameter, action word parameter, power word parameter, polarity parameter, subjectivity parameter, and spam parameter, respectively, and sᵣ, s_{aw}, s_{pw}, sₚ, s_{sub}, and sₛₚₐₘ are scores for readability parameter, action word parameter, power word parameter, polarity parameter, subjectivity parameter, and spam parameter, respectively.

Further, the quality score determination module 208 may select an optimal subject line 214 from the set of alternative subject lines based on the weighted quality score of each of the set of alternative subject lines. For example, the optimal subject line 214 may be the subject line with the highest weighted quality score among the set of alternative subject lines. The optimal subject line 214 may be provided as an output and rendered on the GUI. Additionally, the quality score determination module 208 may send the weighted quality score of each of the set of alternative subject lines to the fine-tuning module 210.

The fine-tuning module 214 may receive the sample subject line and the set of alternative subject lines from the subject line generation module 202, and may receive the weighted quality score of each of the set of alternative subject lines from the quality score determination module 208. Further, the fine-tuning module 214 may fine-tune the LLM using a dataset based on a reinforcement learning technique (for example, a Direct Preference Optimization (DPO) technique).

For each of a plurality of sample subject lines provided by the user, the dataset may include the optimal subject line, a randomly selected subject line from the remaining of the set of alternative subject lines and the weighted quality score corresponding to each of the optimal subject line and the randomly selected subject line. In simpler words, each row of the dataset may include a sample subject line, an optimal subject line from the set of alternative subject lines generated for that sample subject line, a weighted quality score of the optimal subject line, a randomly selected subject line from remaining of the set of alternative subject lines, and a weighted quality score of the randomly selected subject line.

To fine-tune the LLM, the fine-tuning module 210 may, for each of a plurality of sample subject lines, create a pair of subject lines from the dataset to obtain a plurality of pairs of subject lines. The pair of subject lines may include the optimal subject line, the weighted quality score of the optimal subject line, the randomly selected subject line, and the weighted quality score of the randomly selected subject line. Further, the fine-tuning module 210 may create a fine-tuning prompt based on the plurality of pairs of subject lines. Further, the fine-tuning module 210 may inputting the fine-tuning prompt to the LLM to fine-tune the LLM.

As an initial step a supervised fine-tuning process is applied on the LLM. Subsequently, the dataset enriched with the weighted quality scores is employed for DPO fine-tuning. Thus, an off-policy Reinforcement Learning (RL)-based approach is used to fine tune the LLM weights. The weighted quality score is used as a reward for the RL algorithm. It may be noted that in an off-policy RL-based approach, the samples may be collected from the environment and RL may be used to train the LLM offline. By prioritizing subject lines via weighted quality scores, the LLM may be adjusted to emphasize factors crucial for the success of various email marketing strategies.

In other words, the fine-tuning dataset may be prepared using the LLM. Initially, a number of marketing email subject lines (‘n’) may be gathered. Subsequently, for each of these subject lines, a plurality of variations (‘m’) may be generated utilizing the LLM. These variations (i.e., the set of alternative subject lines) are then evaluated based on the weighted quality score. Then, to prepare the fine-tuning dataset, combinations may be formed from the generated variations. Specifically, (m·(m−1))/2 combinations may be created. Within each combination, a determination may be made as to which variation receives an “accepted” tag and which receives a “rejected” tag. This determination is based on the scores assigned to each variation, with the variation having the higher score being tagged as “accepted” and the variation with the lower score being tagged as “rejected”. This methodology ensures the efficient selection and optimization of the fine-tuning dataset, leading to improved engagement and effectiveness in marketing campaigns.

It should be noted that all such aforementioned modules 202-210 may be represented as a single module or a combination of different modules. Further, as will be appreciated by those skilled in the art, each of the modules 202-210 may reside, in whole or in parts, on one device or multiple devices in communication with each other. In some embodiments, each of the modules 202-210 may be implemented as dedicated hardware circuit comprising custom application-specific integrated circuit (ASIC) or gate arrays, off-the-shelf semiconductors such as logic chips, transistors, or other discrete components. Each of the modules 202-210 may also be implemented in a programmable hardware device such as a field programmable gate array (FPGA), programmable array logic, programmable logic device, and so forth. Alternatively, each of the modules 202-210 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating subject lines for emails. For example, the exemplary system 100 and the associated computing device 102 may generate subject lines for emails by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

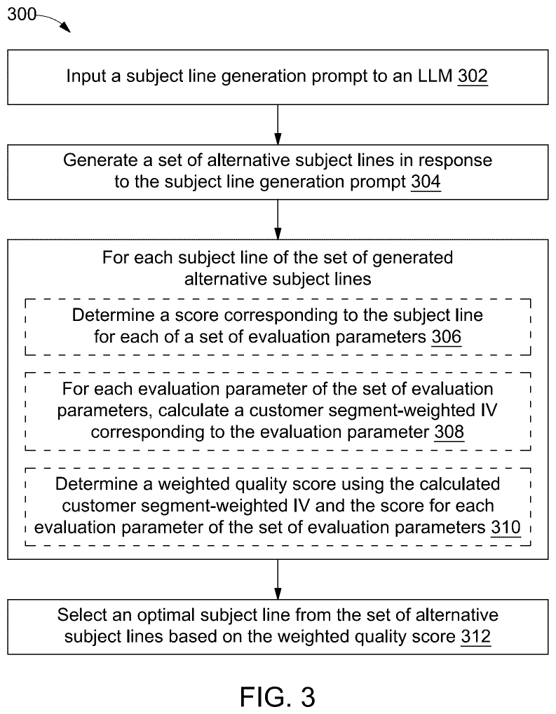

Referring now to FIG. 3, an exemplary method 300 for generating subject lines for emails is depicted via a flowchart, in accordance with some embodiments of the present disclosure. The exemplary process 300 may be implemented by the computing device 102 of the system 100. The process 300 may include inputting, by a subject line generation module (such as the subject line generation module 202), a subject line generation prompt (for example, the subject line generation prompt 212) to an LLM, at step 302. The subject line generation prompt may include a sample subject line for an email, a target customer segment, and instructions to generate a set of alternative subject lines. Further, the process 300 may include generating, by the subject line generation module via the LLM, the set of alternative subject lines in response to the subject line generation prompt, at step 304.

Further, for each subject line of the set of generated alternative subject lines, the process 300 may include determining, by a score determination module (such as the score determination module 204), a score corresponding to the subject line for each of a set of evaluation parameters, at step 306. By way of an example, the set of evaluation parameters may include, but may not be limited to, a readability parameter, an action word parameter, a power word parameter, a polarity parameter, a subjectivity parameter, a spam parameter, and the like.

Further, for each subject line of the set of generated alternative subject lines and for each evaluation parameter of the set of evaluation parameters, the process 300 may include calculating, by an IV calculation module (such as the IV calculation module 206), a customer segment weighted IV corresponding to the evaluation parameter, at step 308. The customer segment weighted IV may be a weighted average of an IV for each of a set of customer segments. It may be noted that the target customer segment may be one of the set of customer segments.

In some embodiments, to calculate the customer segment weighted IV of the evaluation parameter, the process 300 may include calculating, by the IV calculation module, the IV of the evaluation parameter for each of the set of customer segments based on a number of responders and a number of non-responders. The number of responders and the number of non-responders may be obtained from historical email data. Further, the process 300 may include assigning, by the information value calculation module, a weight to each of the set of customer segments based on predefined criteria. Further, the process 300 may include calculating, by the IV calculation module, a weighted average of the IV for each of the set of customer segments using the assigned weight to obtain the customer segment weighted IV corresponding to the evaluation parameter. In some additional embodiments, the process 300 may further include modifying, by the IV calculation module, a current customer segment weighted IV of the evaluation parameter based on a decay factor and a previous customer segment weighted IV of the evaluation parameter. The decay factor is indicative of an impact of the previous customer segment weighted IV on the current customer segment weighted IV.

Further, for each subject line of the set of generated alternative subject lines, the process 300 may include determining, by a quality score determination module (such as the quality score determination module 208), a weighted quality score of the subject line using the calculated customer segment weighted IV and the score for each of the set of evaluation parameters, at step 310. Further, the process 300 may include selecting, by the quality score determination module, an optimal subject line from the set of alternative subject lines based on the weighted quality score, at step 312.

In some embodiments, the process 300 may include fine-tuning, by a fine-tuning module (such as the fine-tuning module 210), the LLM using a dataset based on a reinforcement learning technique (e.g., DPO technique). For each of a plurality of sample subject lines, the dataset may include the optimal subject line, a randomly selected subject line from the remaining of the set of alternative subject lines, and the weighted quality score corresponding to each of the optimal subject line and the randomly selected subject line. Additionally, for each of a plurality of sample subject lines, the process 300 may include creating, by the fine-tuning module, a pair of subject lines from the dataset to obtain a plurality of pairs of subject lines. The pair of subject lines includes the optimal subject line and the weighted quality score of the optimal subject line. The pair of subject lines may further include the randomly selected subject line and the weighted quality score of the randomly selected subject line. Further, the process 300 may include creating, by the fine-tuning module, a fine-tuning prompt based on the plurality of pairs of subject lines. Further, the process 300 may include inputting, by the fine-tuning module, the fine-tuning prompt to the LLM to fine-tune the LLM.

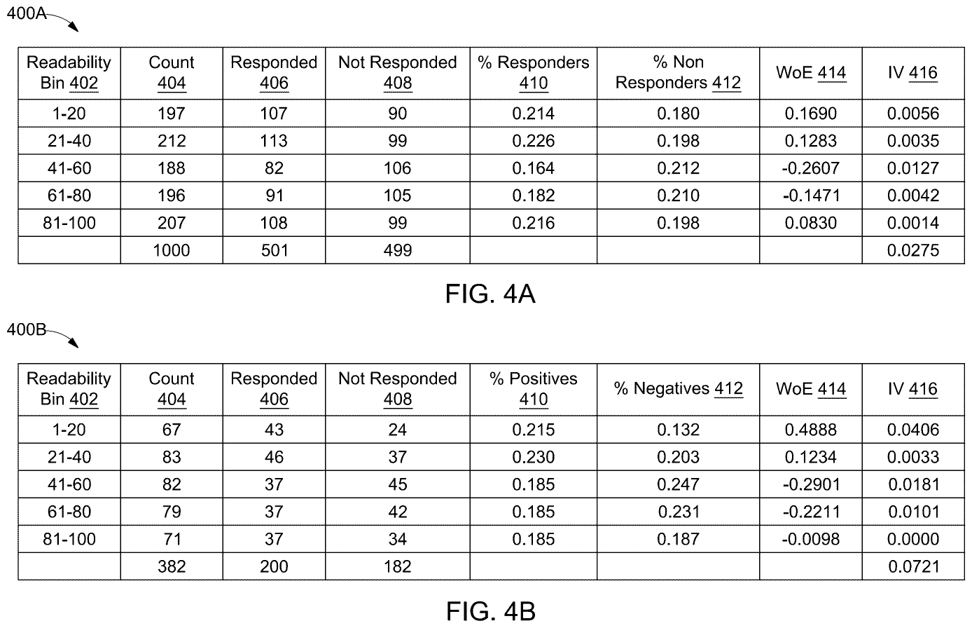

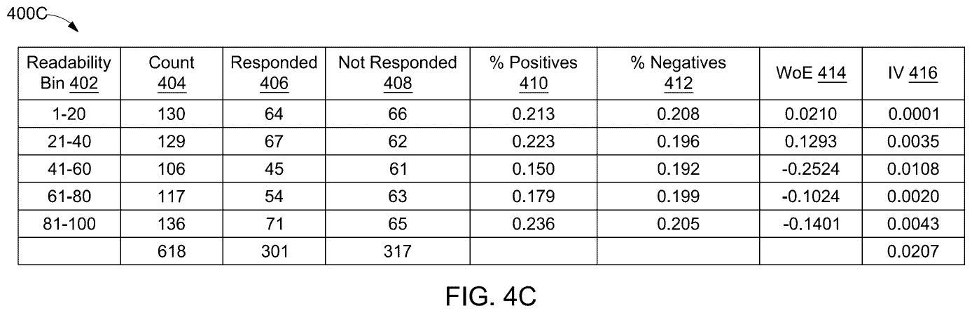

Referring now to FIG. 4A, a table 400A representing experimental results for IV computation of readability parameter based on an exemplary primary dataset is illustrated, in accordance with an embodiment of the present disclosure. The primary dataset may be a simulated dataset of 1000 users that are not divided into further customer segments.

The table 400A may include a column for readability bin 402, a column for count 404 of users, a column for number of responders 406, a column for number of non-responders 408, a column for percentage of responders 410 in the bin, a column for percentage of non-responders 412 in the bin, a column for WoE 414, and a column for IV 416. The column for readability bin 402 includes the set of bins (i.e., ranges) of readability scores. The column for WoE 414 includes the WoE value calculated for the bin using equation (1). The column for IV includes IV values computed for the bin using equations (2), (3) and (5).

In the table 400A, for the readability bins 402 ‘1-20’, ‘21-40’, ‘41-60’, ‘61-80’, and ‘81-100’, the corresponding IV values 416 are ‘0.0056’, ‘0.0035’, ‘0.0127’, ‘0.0042’, and ‘0.0014’, respectively. The total IV value may be calculated as a sum of the IV values 416 of all the readability bins 402. Thus, the total IV value is ‘0.0275’.

Referring now to FIGS. 4B and 4C, tables representing experimental results for IV computations of readability parameter for individual customer segments based on the exemplary primary dataset are illustrated, in accordance with an embodiment of the present disclosure. FIGS. 4B and 4C are explained in conjunction with FIG. 4A.

The primary dataset may include simulated data based on some assumptions. The assumptions are based on three observations from customer data of an enterprise. Firstly, approximately 30-40% of the customers are classified as belonging to the high income group, while the remaining 60-70% are classified as low income, based on predefined income thresholds. Thus, two customer segments may be created based on income levels of the users. A first customer segment may correspond to a high income group and a second customer segment may correspond to a low income group. Secondly, the response rate is slightly higher among customers in the high income group compared to those in the low income group. Thirdly, for the low income group, easier readability (higher readability score) attracts more response. On the other hand, for the high income group, standard readability (lower readability score) has more responders. Based on the above observations and assumptions, the primary dataset is generated to analyze the IV across different customer segments.

In FIG. 4B, a table 400B is shown. The table 400B may be based on a high-income dataset derived from the primary dataset. The high income dataset may include 382 users from the 1000 users in the primary dataset. The table 400B may include the column for readability bin 402, the column for count 404 of users, the column for number of responders 406, the column for number of non-responders 408, the column for percentage of responders 410 in the bin, the column for percentage of non-responders 412 in the bin, the column for WoE 414, and the column for IV 416.

In the table 400B, for the readability bins 402 ‘1-20’, ‘21-40’, ‘41-60’, ‘61-80’, and ‘81-100’, the corresponding IV values 416 are ‘0.0406’, ‘0.0033’, ‘0.0181’, ‘0.0101’, and ‘0.0000’, respectively. The total IV value may be calculated as a sum of the IV values 416 of all the readability bins 402. Thus, the total IV value is ‘0.0721’.

In FIG. 4C, a table 400C is shown. The table 400C may be based on a low income dataset 400C. derived from the primary dataset. The low income dataset may include 618 users from the 1000 users in the primary dataset. The table 400C may include the column for readability bin 402, the column for count 404 of users, the column for number of responders 406, the column for number of non-responders 408, the column for percentage of responders 410 in the bin, the column for percentage of non-responders 412 in the bin, the column for WoE 414, and the column for IV 416.

In the table 400C, for the readability bins 402 ‘1-20’, ‘21-40’, ‘41-60’, ‘61-80’, and ‘81-100’, the corresponding IV values 416 are ‘0.0001’, ‘0.0035’, ‘0.0108’, ‘0.0020’, and ‘0.0043’, respectively. The total IV value may be calculated as a sum of the IV values 416 of all the readability bins 402. Thus, the total IV value is ‘0.0207’.

The overall IV (obtained from the table 400A) is 0.0275, whereas for the low income group, the IV (obtained from the table 400C) is 0.0207, and for the high income group, the IV (obtained from the table 400B) is significantly higher, at 0.0721. This disparity suggests that the overall IV may not accurately represent the influence of the readability score within the high income group. Therefore, employing a weighted IV may be a more effective method to accurately reflect the distinct impacts of different income segments on customer responses. The customer segment weighted IV (using weights 0.6 for the high income group and 0.4 for the low income group) may be calculated using the equation (4).

$${IV}_{readability , weighted} = 0.6 * 0.0721 + 0.4 * 0.0207 = 0.052$$

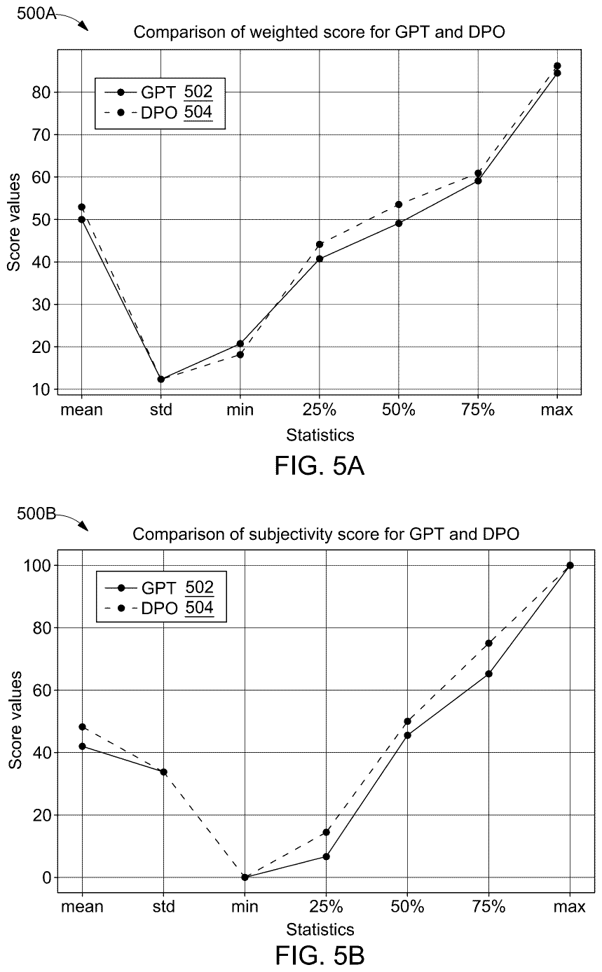

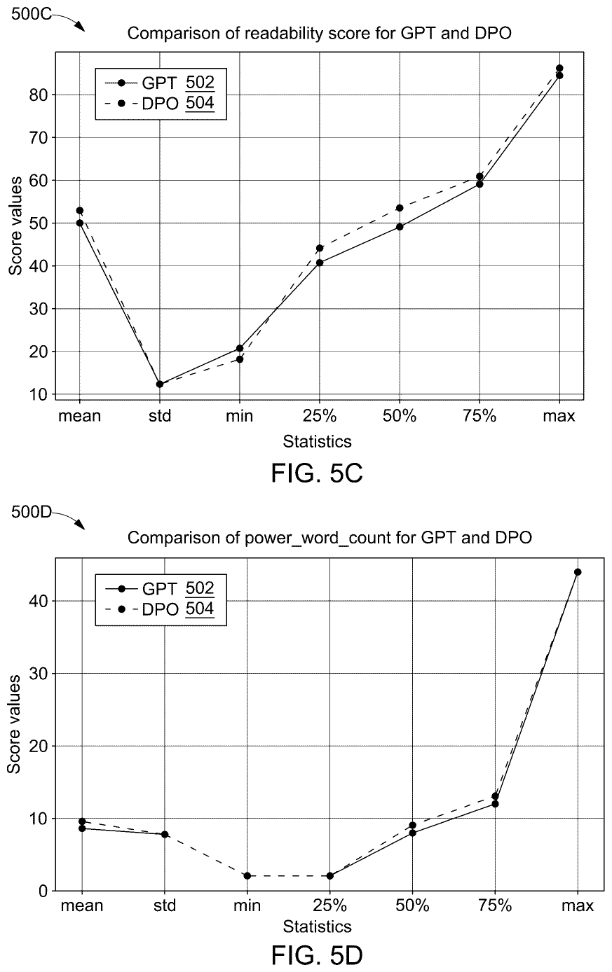

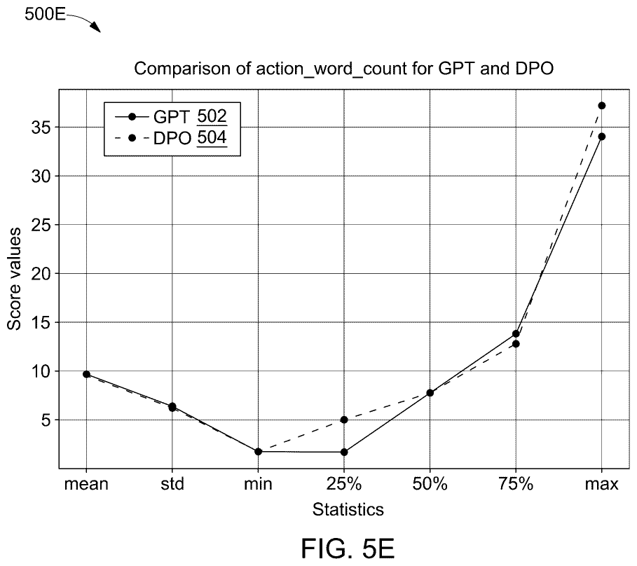

Referring now to FIGS. 5A-5E, exemplary graphical representations of a comparison between a raw GPT-4 model and a DPO fine-tuned Mistral-7B model are illustrated, in accordance with an embodiment of the present disclosure. The raw GPT-4 model is compared to an open source Mistral-7B-Instruct-v0.1 model (herein referred to as “DPO fine-tuned Mistral-7B model”). The DPO fine-tuned Mistral-7B model is fine-tuned for 5 epochs. The fine-tuned DPO model computes approximately 7%-8% better results than the raw GPT-4 model on the basis of experiments.

In FIG. 5A, an exemplary graph 500A is shown. The graph 500A shows a comparison of the weighted quality score calculation by the raw GPT-4 502 and the DPO fine-tuned Mistral-7B model 504. The y-axis of the graph 500A depicts the score values and the x-axis of the graph 500A depicts various statistics values (for example, a mean, a standard deviation (std), a minimum value (min), a first quartile (25^{th} percentile), a second quartile or median (50^{th} percentile), a second quartile (75^{th} percentile), a maximum value (max), and the like). The graph 500A shows that the DPO fine-tuned Mistral-7B model 504 outperforms the raw GPT-4 model 502 in weighted quality score calculation.

In FIG. 5B, an exemplary graph 500B is shown. The graph 500B shows a comparison of subjectivity score (i.e., the subjectivity parameter) calculation by the raw GPT-4 502 and the DPO fine-tuned Mistral-7B model 504. The y-axis of the graph 500B depicts the score values and the x-axis of the graph 500B depicts various statistics values (for example, a mean, a standard deviation (std), a minimum value (min), a first quartile (25^{th} percentile), a second quartile or median (50^{th} percentile), a second quartile (75^{th} percentile), a maximum value (max), and the like). The graph 500B shows that the DPO fine-tuned Mistral-7B model 504 outperforms the raw GPT-4 model 502 in subjectivity score calculation. The subjectivity score, basically determines how much the generated subject is in a descriptive or a subjective format. The graph 500B shows that the DPO fine-tuned Mistral-7B model 504 is giving more subjective text than the raw GPT-4 model 502.

In FIG. 5C, an exemplary graph 500C is shown. The graph 500C shows a comparison of readability score (i.e., the readability parameter) calculation by the raw GPT-4 502 and the DPO fine-tuned Mistral-7B model 504. The y-axis of the graph 500C depicts the score values and the x-axis of the graph 500C depicts various statistics values (for example, a mean, a standard deviation (std), a minimum value (min), a first quartile (25^{th} percentile), a second quartile or median (50^{th} percentile), a second quartile (75^{th} percentile), a maximum value (max), and the like). The graph 500C shows that the DPO fine-tuned Mistral-7B model 504 outperforms the raw GPT-4 model 502 in readability score calculation. The readability score also measures the comprehensiveness of a text. The graph 500C shows that the DPO fine-tuned Mistral-7B model 504 is giving more comprehensive text than the raw GPT-4 model 502.

In FIG. 5D, an exemplary graph 500D is shown. The graph 500D shows a comparison of power word count (i.e., the power word parameter) calculation by the raw GPT-4 502 and the DPO fine-tuned Mistral-7B model 504. The y-axis of the graph 500D depicts the score values and the x-axis of the graph 500D depicts various statistics values (for example, a mean, a standard deviation (std), a minimum value (min), a first quartile (25^{th} percentile), a second quartile or median (50^{th} percentile), a second quartile (75^{th} percentile), a maximum value (max), and the like). The graph 500D shows that the DPO fine-tuned Mistral-7B model 504 outperforms the raw GPT-4 model 502 in power word count calculation. The graph 500D shows that the DPO fine-tuned Mistral-7B model 504 is generating a slightly more power word count than the raw GPT-4 model 502.

In FIG. 5E, an exemplary graph 500E is shown. The graph 500E shows a comparison of action word count (i.e., the action word parameter) calculation by the raw GPT-4 502 and the DPO fine-tuned Mistral-7B model 504. The y-axis of the graph 500E depicts the score values and the x-axis of the graph 500E depicts various statistics values (for example, a mean, a standard deviation (std), a minimum value (min), a first quartile (25^{th} percentile), a second quartile or median (50^{th} percentile), a second quartile (75^{th} percentile), a maximum value (max), and the like). The graph 500E shows that the DPO fine-tuned Mistral-7B model 504 outperforms the raw GPT-4 model 502 in action word count calculation. The graph 500E shows that the DPO fine-tuned Mistral-7B model 504 is generating subject lines which have more action words than the raw GPT-4 model 502.

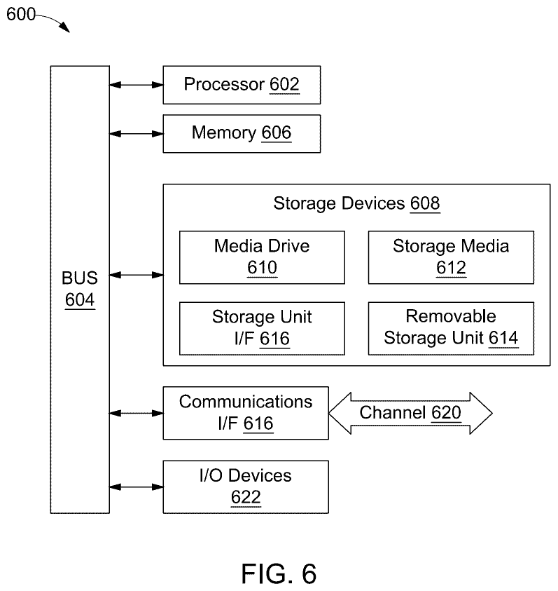

The disclosed methods and systems may be implemented on a conventional or a general-purpose computer system, such as a personal computer (PC) or server computer. Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication medium. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during execution of instructions to be executed by the processor 602. The computing system 600 may likewise include a read only memory (“ROM”) or other static storage device coupled to bus 604 for storing static information and instructions for the processor 602.

The computing system 600 may also include a storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 612 may include, for example, a hard disk, magnetic tape, flash drive, or other fixed or removable medium that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 814 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro-USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or another communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 800 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

Various embodiments provide method and system for generating subject lines for emails. The disclosed method and system may input a subject line generation prompt to an LLM. The subject line generation prompt includes a sample subject line for an email, a target customer segment, and instructions for alternative subject line generation. Further, the disclosed method and system may generate a set of alternative subject lines in response to the subject line generation prompt. Further, the disclosed method and system, for each subject line of the set of generated alternative subject lines, may determine a score corresponding to the subject line for each of a set of evaluation parameters. Further, the disclosed method and system, for each subject line of the set of generated alternative subject lines, for each evaluation parameter of the set of evaluation parameters, may calculate a customer segment weighted IV corresponding to the evaluation parameter. The customer segment weighted IV may be a weighted average of an IV for each of a set of customer segments. The target customer segment may be one of the set of customer segments Further, the disclosed method and system, for each subject line of the set of generated alternative subject lines, may determine a weighted quality score using the calculated customer segment weighted IV and the score for the each of the set of evaluation parameters. Further, the disclosed method and system may select an optimal subject line from the set of alternative subject lines based on the weighted quality score.

Thus, the disclosed techniques try to overcome the logical problem for generating subject lines for e-mails. The techniques provide an enhanced email engagement by improving the effectiveness of email campaigns. Further, the techniques may facilitate more informed, data-driven decisions regarding email content strategies and may optimize marketing efforts. Further, the techniques may tackle scalability, accommodating a wide range of email marketing strategies. Further, the techniques provide a straightforward yet effective method for assessing the quality of a set of email subject lines, facilitating rapid implementation and immediate improvements in marketing communications. Further, the techniques provide optimized AI model adaptability. The weighted scores are incorporated into the fine-tuning of the Generative AI model or LLM for creating email subject lines, which enhances the model's accuracy, relevance, and generates more effective subject lines.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has a described method and system for generating subject lines for e-mails. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating subject lines for electronic mails (emails), the method comprising:
inputting, by a processor, a subject line generation prompt to a Large Language Model (LLM), wherein the subject line generation prompt comprises a sample subject line for an email, a target customer segment, and instructions for alternative subject line generation;
generating, by the processor and via the LLM, a set of alternative subject lines in response to the subject line generation prompt;
for each subject line of the set of generated alternative subject lines,
determining, by the processor, a score corresponding to the subject line for each of a set of evaluation parameters;
for each evaluation parameter of the set of evaluation parameters, calculating, by the processor, a customer segment weighted information value (IV) corresponding to the evaluation parameter, wherein the customer segment weighted IV is a weighted average of an IV for each of a set of customer segments, wherein the target customer segment is one of the set of customer segments; and
determining, by the processor, a weighted quality score of the subject line using the calculated customer segment weighted IV and the score for each of the set of evaluation parameters; and
selecting, by the processor, an optimal subject line from the set of alternative subject lines based on the weighted quality score.

2. The method of claim 1, wherein calculating the customer segment weighted IV corresponding to the evaluation parameter comprises:
for each evaluation parameter of the set of evaluation parameters,
calculating the IV of the evaluation parameter for each of the set of customer segments based on a number of responders and a number of non-responders, wherein the number of responders and the number of non-responders are obtained from historical email data;
assigning a weight to each of the set of customer segments based on predefined criteria; and
calculating a weighted average of the IV for each of the set of customer segments using the assigned weight to obtain the customer segment weighted IV corresponding to the evaluation parameter.

3. The method of claim 2, further comprising:
for each evaluation parameter of the set of evaluation parameters:
modifying a current customer segment weighted IV of the evaluation parameter based on a decay factor and a previous customer segment weighted IV of the evaluation parameter, wherein the decay factor is indicative of an impact of the previous customer segment weighted IV on the current customer segment weighted IV.

4. The method of claim 1, further comprising:
fine-tuning the LLM using a dataset based on a reinforcement learning technique, wherein for each of a plurality of sample subject lines, the dataset comprises:
the optimal subject line,
a randomly selected subject line from a remaining of the set of alternative subject lines, and
the weighted quality score corresponding to each of the optimal subject line and the randomly selected subject line.

5. The method of claim 4, wherein fine-tuning the LLM comprises:
for each of a plurality of sample subject lines, creating a pair of subject lines from the dataset to obtain a plurality of pairs of subject lines, wherein the pair of subject lines comprises:
the optimal subject line and the weighted quality score of the optimal subject line, and
the randomly selected subject line and the weighted quality score of the randomly selected subject line;
creating a fine-tuning prompt based on the plurality of pairs of subject lines; and
inputting the fine-tuning prompt to the LLM to fine-tune the LLM.

6. A system for generating subject lines for e-mails, the system comprising:
a processor; and
a computer-readable medium communicatively coupled to the processor, wherein the computer-readable medium stores processor-executable instructions, which when executed by the processor, cause the processor to:
input a subject line generation prompt to an LLM, wherein the subject line generation prompt comprises a sample subject line for an email, a target customer segment, and instructions for alternative subject line generation;
generate a set of alternative subject lines in response to the subject line generation prompt;
for each subject line of the set of generated alternative subject lines,
determine a score corresponding to the subject line for each of a set of evaluation parameters;
for each evaluation parameter of the set of evaluation parameters, calculate a customer segment weighted IV corresponding to the evaluation parameter, wherein the customer segment weighted IV is a weighted average of an IV for each of a set of customer segments, wherein the target customer segment is one of the set of customer segments; and
determine a weighted quality score of the subject line using the calculated customer segment weighted IV and the score for each of the set of evaluation parameters; and
select an optimal subject line from the set of alternative subject lines based on the weighted quality score.

7. The system of claim 6, wherein calculating the customer segment weighted IV corresponding to the evaluation parameter comprises:
for each evaluation parameter of the set of evaluation parameters,
calculate the IV of the evaluation parameter for each of the set of customer segments based on a number of responders and a number of non-responders, wherein the number of responders and the number of non-responders are obtained from historical e-mail data;
assign a weight to each of the set of customer segments based on predefined criteria; and
calculate a weighted average of the IV for each of the set of customer segments using the assigned weight to obtain the customer segment weighted IV corresponding to the evaluation parameter.

8. The system of claim 7, wherein the processor instructions, on execution, further cause the processor to:
for each evaluation parameter of the set of evaluation parameters:
modify a current customer segment weighted IV of the evaluation parameter based on a decay factor and a previous customer segment weighted IV of the evaluation parameter, wherein the decay factor is indicative of an impact of the previous customer segment weighted IV on the current customer segment weighted IV.

9. The system of claim 6, wherein the processor instructions, on execution, further cause the processor to:
fine-tune the LLM using a dataset based on a reinforcement learning technique, wherein for each of a plurality of sample subject lines, the dataset comprises:
the optimal subject line,
a randomly selected subject line from a remaining of the set of alternative subject lines, and
the weighted quality score corresponding to each of the optimal subject line and the randomly selected subject line.

10. The system of claim 9, wherein fine-tuning the LLM comprises:
for each of a plurality of sample subject lines, creating a pair of subject lines from the dataset to obtain a plurality of pairs of subject lines, wherein the pair of subject lines comprises:
the optimal subject line and the weighted quality score of the optimal subject line, and
the randomly selected subject line and the weighted quality score of the randomly selected subject line;
create a fine-tuning prompt based on the plurality of pairs of subject lines; and
input the fine-tuning prompt to the LLM to fine-tune the LLM.

11. A non-transitory computer-readable medium storing computer-executable instructions for generating subject lines for e-mails, the computer-executable instructions configured for:
inputting a subject line generation prompt to an LLM, wherein the subject line generation prompt comprises a sample subject line for an email, a target customer segment, and instructions for alternative subject line generation;
generating a set of alternative subject lines in response to the subject line generation prompt;
for each subject line of the set of generated alternative subject lines,
determining a score corresponding to the subject line for each of a set of evaluation parameters;
for each evaluation parameter of the set of evaluation parameters, calculating a customer segment weighted IV corresponding to the evaluation parameter, wherein the customer segment weighted IV is a weighted average of an IV for each of a set of customer segments, wherein the target customer segment is one of the set of customer segments; and
determining a weighted quality score of the subject line using the calculated customer segment weighted IV and the score for each of the set of evaluation parameters; and
selecting an optimal subject line from the set of alternative subject lines based on the weighted quality score.

12. The non-transitory computer-readable medium of claim 11, wherein calculating the customer segment weighted IV corresponding to the evaluation parameter comprises:
for each evaluation parameter of the set of evaluation parameters,
calculating the IV of the evaluation parameter for each of the set of customer segments based on a number of responders and a number of non-responders, wherein the number of responders and the number of non-responders are obtained from historical e-mail data;
assigning a weight to each of the set of customer segments based on predefined criteria; and
calculating a weighted average of the IV for each of the set of customer segments using the assigned weight to obtain the customer segment weighted IV corresponding to the evaluation parameter.

13. The non-transitory computer-readable medium of claim 12, further comprising:
for each evaluation parameter of the set of evaluation parameters,
modifying a current customer segment weighted IV of the evaluation parameter based on a decay factor and a previous customer segment weighted IV of the evaluation parameter, wherein the decay factor is indicative of an impact of the previous customer segment weighted IV on the current customer segment weighted IV.

14. The non-transitory computer-readable medium of claim 11, further comprising:
fine-tuning the LLM using a dataset based on a reinforcement learning technique, wherein for each of a plurality of sample subject lines, the dataset comprises:
the optimal subject line,
a randomly selected subject line from a remaining of the set of alternative subject lines, and
the weighted quality score corresponding to each of the optimal subject line and the randomly selected subject line.

15. The non-transitory computer-readable medium of claim 14, wherein fine-tuning the LLM comprises:
for each of a plurality of sample subject lines, creating a pair of subject lines from the dataset to obtain a plurality of pairs of subject lines, wherein the pair of subject lines comprises:
the optimal subject line and the weighted quality score of the optimal subject line, and
the randomly selected subject line and the weighted quality score of the randomly selected subject line;
creating a fine-tuning prompt based on the plurality of pairs of subject lines; and
inputting the fine-tuning prompt to the LLM to fine-tune the LLM.
